(19) United States
(12) Patent Application Publication
(10) Pub. No.: US 2014/0017976 A1
(43) Pub. Date: Jan. 16, 2014

(54) BOTTOM BOARD FOR SUPPORTING A HONEY BEE HIVE

(71) Applicant: Athanasios YIANNIBAS, Charlotte, NC (US)

(72) Inventor: Athanasios YIANNIBAS, Charlotte, NC (US)

(21) Appl. No.: 13/546,556

(22) Filed: Jul. 11, 2012

(51) Int. Cl. A01K 47/02

(52) U.S. Cl. 449/26

(57) ABSTRACT

A bottom board for supporting a honey bee hive which has a board, three vertical walls extending above and below the board, with a first groove opening that extends between two parallel vertical walls wherein a screen covers the first groove opening and an aperture extends thru the one of the two vertical walls that is in communication with the first groove opening and whereby one end of a tray extends thru the aperture so that a beekeeper has access to the tray without disturbing the remainder of the hive.

### FIELD OF THE INVENTION

The present invention concerns a honey bee hive and specifically a bottom board for supporting the honey bee hive. Traditionally, bottom boards for honey bee hives are either solid or have a screen opening and may be constructed of wood or plastic. The present invention provides a built-in trap for small hive beetles that have become a real problem in recent years for beekeepers. The advantage of the present invention is that the trap can be accessed outside the hive, without opening any portion of the hive. The trap includes a tray which can be extracted from the bottom board exterior, can be cleaned and refilled with a small hive beetle attractant, or a liquid which causes the small hive beetle to drown.

### PRIOR ART

The simplest structure of the hive for honey bees generally consists of a bottom board, a hive body with frames where the bees live, an inner cover, and an overlapping outer cover. This simple description of a hive for honey bees is the minimum needed, but it can be much more involved with additional hive bodies, queen excluders, honey supers, feeders, etc.

In recent years, the small hive beetle has spread across the Unites States and become a potential problem for a colony of honey bees. The small hive beetle, if it gains control of the hive, can lay eggs therein, and the larvae of the small hive beetle will consume baby brood, pollen, honey, beeswax, etc. In short, small hive beetles can totally destroy a colony of honey bees and cause them to swarm to find a new home.

No chemicals have been identified which are capable of preventing an infestation of the small hive beetle in a colony of honey bees. However, there are some measures that can be taken to control an infestation of small hive beetles. It is known that small hive beetles can not swim. Setting up traps within the hive such that the honey bees can chase the small hive beetles into the traps is one way to control the small hive beetle especially when the trap has liquid therein that causes the small hive beetle to drown. The problem with these types of traps is that the beekeeper must regularly enter the hive, clean out the traps, introduce more liquid, and re-insert or replace the traps. This is inconvenient for the beekeeper as well as an interruption of the colony of bees performing their daily chores. Thus a need exists for a trap for the small hive beetle that entails less disruption for the colony of bees, and is more convenient for the beekeeper. It is an object of the present invention to provide a small hive beetle trap in the bottom board that is convenient for the beekeeper and causes significantly less disruption for the colony of honey bees.

### BRIEF SUMMARY OF THE INVENTION

Because small hive beetles can fly, they frequently enter a hive of honey bees by the same method as honey bees themselves—they simple fly to the opening and walk in. Honey bees recognize the invasive nature of small hive beetles and what they are capable of doing to the hive, namely consume beeswax, honey, nectar, pollen, and more particularly brood of the honey bees. Accordingly, honey bees frequently chase small hive beetles around the hive and have been known to imprison them in walls of wax. If the beekeeper has small hive beetle traps position throughout the interior of the hive, it is known that honey bees frequently chase the small hive beetle into these traps where they drown if the trap contains liquid.

The inventor of the present invention has invented a bottom board having at least one or more small hive beetle traps. These traps are easily accessible from outside the hive, thereby causing less disruption to the daily life of the colony of bees and thereby being more convenient for the beekeeper.

In the broadest sense, the present invention concerns a bottom board for supporting a hive of honey bees comprising a flat surface, three vertical walls attached to an extending above and below said flat surface, wherein two of said vertical walls are parallel and the third vertical wall extends between said two parallel vertical walls, said board having a first groove opening that extends across said flat surface between said two parallel vertical walls, one of said two vertical walls having an aperture there through, in alignment with said first groove opening, said first groove opening covered over with screen wire of a size that easily permits honeybees to walk across the top without falling through said screen wire, but small hive beetles can fit through said screen wire, and a tray that fits within said first groove opening wherein said tray opens upward, toward said screen wire, said tray having one end that extends out through said aperture, said tray being capable of siding into and out of said aperture and said first groove opening thereby allowing access to the interior of said tray.

### BRIEF DESCRIPTION OF THE DRAWINGS

FIGS. 1-5 illustrate, according to the aspects of the present invention, the subject matter thereof.

FIG. 1 is a perspective view of the bottom board of the present invention.

FIG. 2 is a partial view of the bottom board of the present invention illustrating the tray sliding in/out of the bottom board.

FIG. 3 is a top or plan view of the bottom board of the present invention.

FIG. 4 is a cut-away view along line 4-4 shown in FIG. 3, thereby illustrating the bottom board, screen and tray.

FIG. 5 is a perspective view of the bottom board of the present invention with a solid surface designed to fit within the grooves, and a dotted outline of a hive positioned on said bottom board.

### DESCRIPTION OF THE PREFERRED EMBODIMENTS

Hives and particularly the bottom board of hives may be made from wood or plastic and is known in the industry.

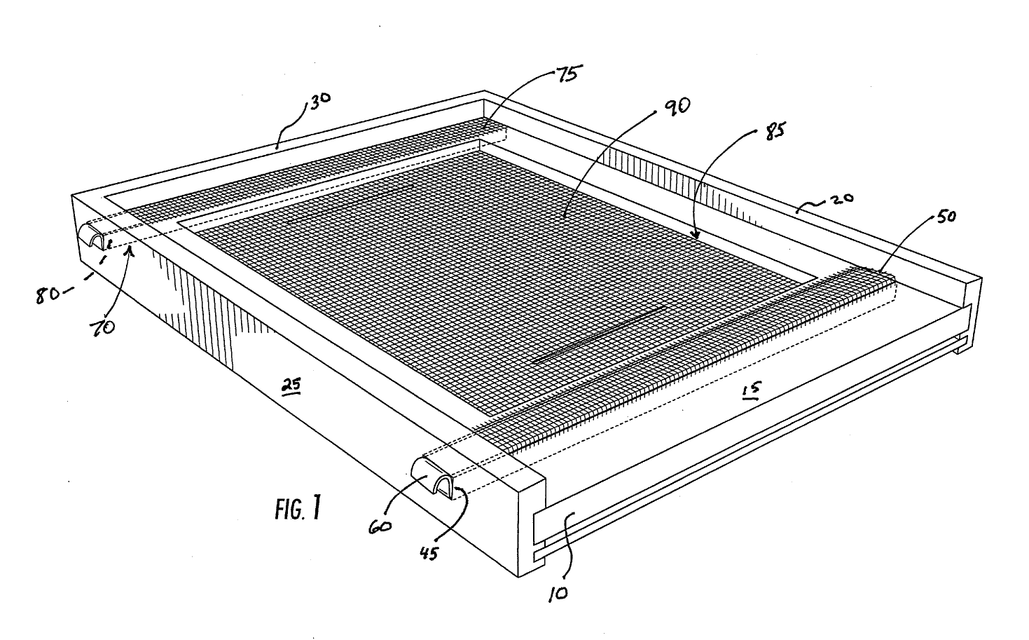

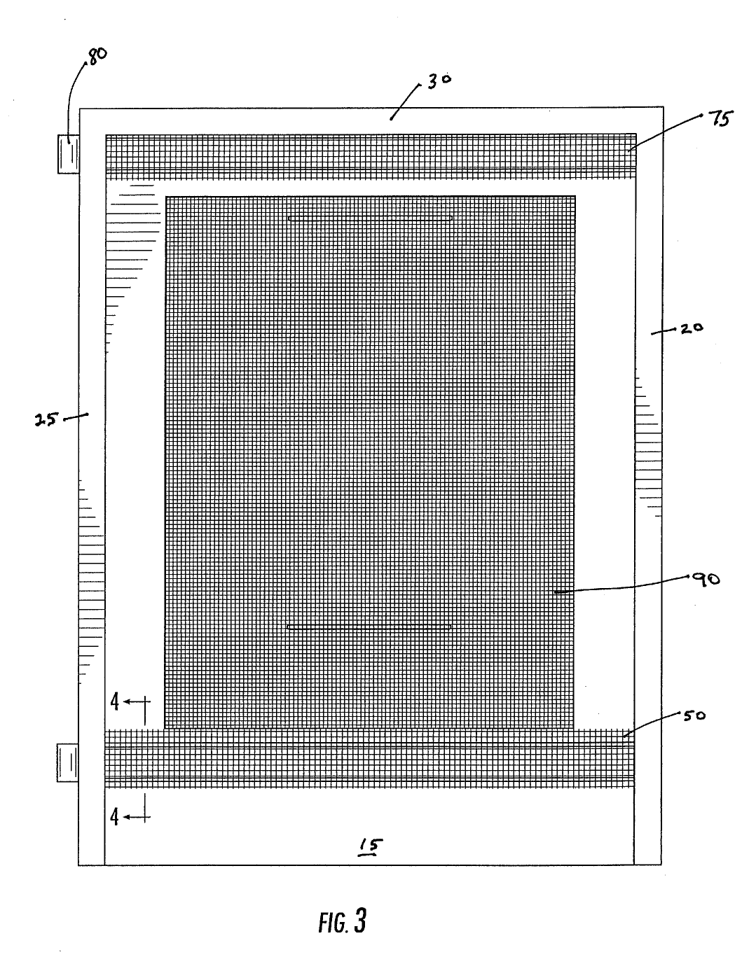

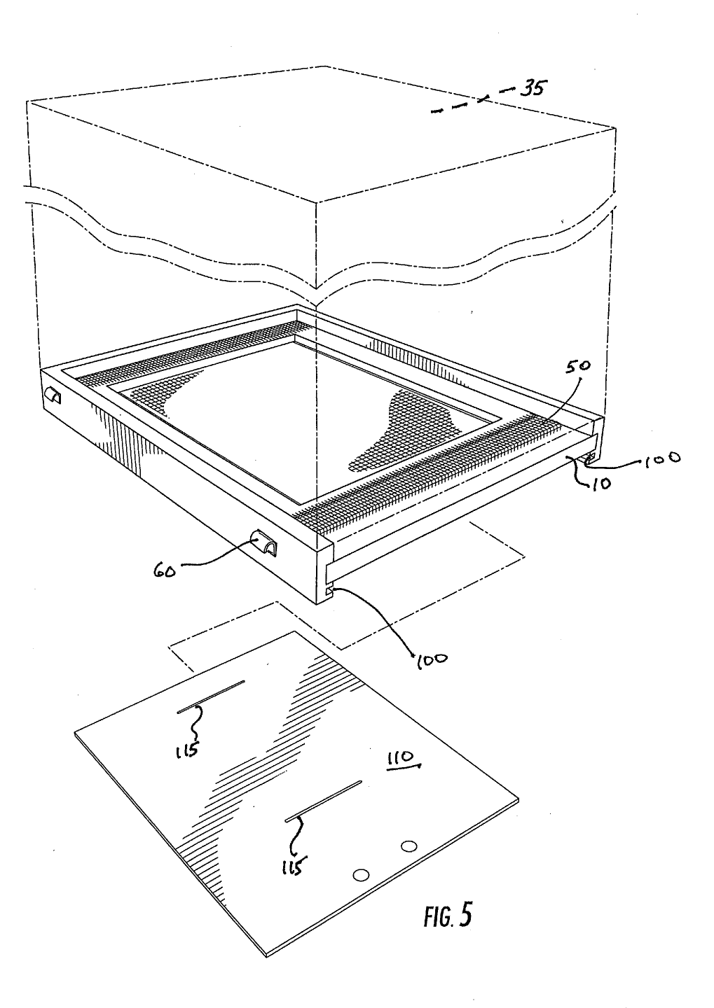

As illustrated in FIGS. 1-5, the bottom board of the present invention has a board 10 with a flat upper surface 15 and three vertical walls 20, 25 and 30 which extend above and below the board 10 and the flat surface 15. Vertical wall 20 and 25 are parallel to one another and vertical wall 30 extends between these two parallel walls all as clearly illustrated in FIG. 1. Note that the height of vertical walls 20, 25 and 30 extend the same distance above the flat upper surface 15 as well as the same distance below board 10, thus acting as an edge support for the hive illustrated in phantom in FIG. 5 by reference number 35. The details of the hive 35 are known to those skilled in the art and do not affect the present invention.

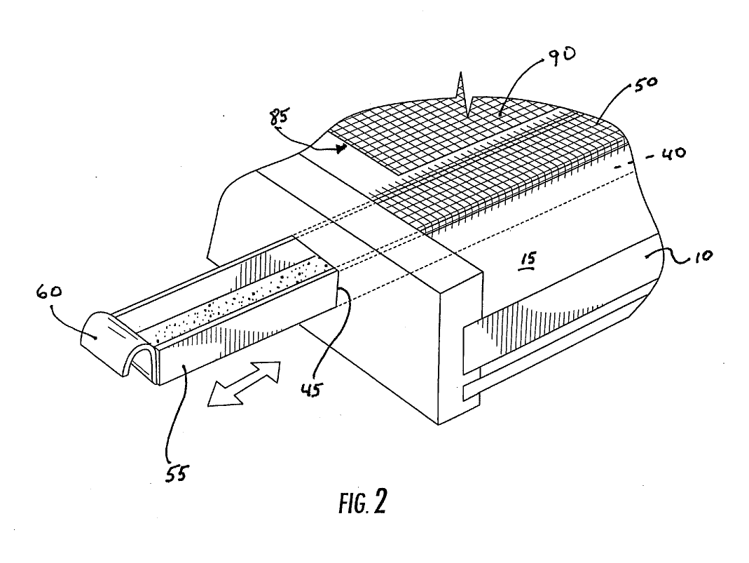

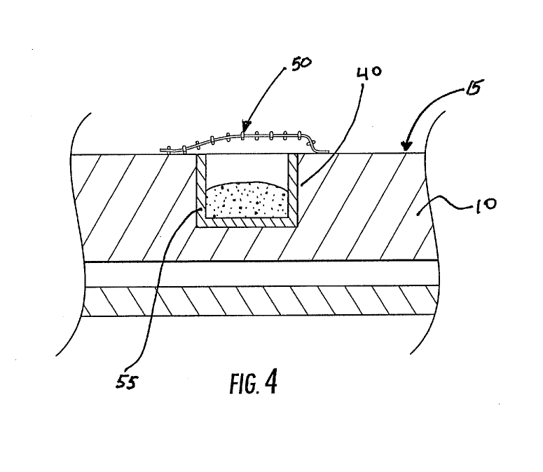

As illustrated in FIGS. 1, 2 and particularly 4, board 10 has a first groove opening 40 which extends thru flat upper surface 15 but does not extend thru board 10 as illustrated more accurately in FIG. 4. The first groove opening 40 extends into board 10, as shown in FIG. 4, or it may extend entirely through board 10, from vertical parallel wall 20 to vertical parallel wall 25. Vertical parallel wall 25 has an aperture 45 extending entirely thru the thickness of the wall 25 and is in alignment with the first groove opening 40 as illustrated in FIG. 2. Covering the top of the first groove opening 40 is screen wire 50 which extends from vertical parallel wall 20 to vertical parallel wall 25 as illustrated in FIG. 1. The screen wire 50 is of a size that permits the honey bee to easily walk across the screen wire. However, the screen wire is also of a size that it permits the much smaller hive beetle to easily pass thru screen wire 50 thus falling into the first groove opening 40. Typically, screen wire 50 is #8 mesh meaning that the screen wire has 8 openings per inch is both directions of the screen. Typically it is agreed that bee space is 5/16 to ⅜ inch. Bee space is the space that is sufficient to allow bees to pass thru the space. Accordingly, this means that #6 mesh and #4 mesh may also be employed, as these meshes have 6 openings per inch and 4 openings per inch, respectively, in each direction of the screen. In the industry, it is believed that #4 mesh may very well allow newly adult bees, which may be smaller than a full grown adult (at least for a couple of days) to squeeze thru #4 mesh screen.

Within the first groove opening 40 is a tray 55 more clearly shown in FIGS. 2 and 4. The tray may be made from wood, metal, or plastic. Preferably, the tray is made from metal and is fully capable of holding liquid therein. The opening of the tray 55 faces upward toward the screen wire 50. One end of tray 55 has a handle 60 which can take any shape so long as it aids the beekeeper to extract the tray 55 from the first groove opening 40, thru the aperture 45 of the vertical wall 25. The tray 55 may contain a liquid or solid, that aids in eliminating or reducing the number of small hive beetles. If the tray, for example, contains liquid, small hive beetles can enter thru the screen wire 50, fall into the first groove opening 40 and into tray 55, thereby drowning in the liquid. The beekeeper may then easily and frequently check the tray 55 by merely pulling it out and seeing if it needs more liquid or if it is full of small hive beetles. The small hive beetles can be simply dumped on the ground and the tray refilled with liquid and re-inserted into the hive.

Optionally, a second groove opening 70 (See FIG. 1) can be positioned between vertical parallel wall 20 and vertical parallel wall 25, include a screen wire covering 75, and a second tray 80. This second groove opening 70 with screen wire 75 and tray 80 would basically be identical to the first groove opening 40 with its screen wire 50 and tray 55, however, it would be positioned further within the interior of the bottom board, such as near or along the third vertical wall 30.

While the bottom board discussed so far can easily be a solid board, it is more popular to have screen bottom boards. Thus, the bottom board 10, illustrated in FIG. 1 has a rectangular hole 85 which is covered by screen wire 90 to allow good ventilation to occur thru the bee hive. Air entering thru the screen 90 of the bottom board 10 will have a chimney effect throughout the hive and will exit thru the overlapping outer cover as is known. The screen opening allows air to flow through the hive. The screen wire 90 is such that small hive beetles may or may not drop out through the openings of the screen wire. On the other hand honey bees cannot. What is known as ⅛ inch screen wire is suitable for this purpose (⅛ inch screen wire is generally an opening in the screen that is ⅛ inch by ⅛ inch such that approximately 8 of these openings comprise a linear inch in the screen wire). Preferably the screen wire 90 is a smaller size than screen wire 50 and 75, in that it will retain both the honey bee and the small hive beetle. In this sense, it is different from the screen wire 50 and 75. Thus, in this embodiment the only place for the small hive beetle to enter the hive would be the normal entrance on the flat surface 15 of the bottom board. The entrance is created due to the lack of a vertical wall, across from the third vertical wall 30.

As illustrated in FIG. 5, the entrance is between the flat surface 15 and the bottom of a hive body shown in dotted line. Guard honey bees are typically stationed along the entrance and thus any small hive beetle which lands on the flat surface 15 would then immediately be chased out of the hive or into and thru screen wire 50 into tray 55. Should small hive beetles make it into the hive, it is very typical that they go to the back of the hive along the third vertical wall 30. Thus, when bees chase them at this point, they will quickly run thru screen 75 and into tray 80 where their death should be imminent due to the liquid contained within the tray.

As shown in FIG. 5, a pair of channels 100 are positioned below the board 10 in parallel vertical wall 20 and 25. These channels 100 are designed to hold either a white cardboard employed to count varroa mites or a solid surface 110 which can be inserted into the channels 100 thereby blocking the air flow thru the screen bottom board. The solid surface 110 may typically used in winter to permit the hive to retain more heat. Even in winter, it is necessary for some ventilation to enter the hive to eliminate moisture via the chimney effect by transporting hot moist air from the bottom of the hive thru and out the top of the hive as in known to those skilled in the art. Thus, the solid surface 110 may have one or more slit openings 115 therein to allow a minor amount of air to flow into the hive as illustrated in FIG. 5.

Thus it is apparent, that there has been provided, in accordance with the invention, a bottom board that fully satisfies the objects, aims and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications and variations as fall within the spirit and broad scope of the appended claims.

What is claimed is:

1) A bottom board for supporting a hive for honeybees, comprising
a board having a flat surface,
three vertical walls attached to and extending above and below said flat surface, wherein two of said vertical walls are parallel and the third vertical wall extends between said two parallel vertical walls,
said board having a first groove opening that extends across said flat surface between said two parallel vertical walls,
one of said two vertical walls having an aperture there through, in alignment with said first groove opening,
said first groove opening covered over with screen wire of a size that easily permits honeybees to walk across the top without falling through said screen wire, but small hive beetles can fit through said screen wire, and
a tray that fits within said first groove opening wherein said tray opens upward, toward said screen wire, said tray having one end that extends out through said aperture, said tray being capable of siding into and out of said aperture and said first groove opening thereby allowing access to the interior of said tray.

2) The bottom board of claim 1, wherein said board has a hole covering the majority of the area calculated by multiplying the length of a parallel wall by the length of the third vertical wall, said hole being covered by screen wire of a size that easily permits honeybees to walk across the top of it without falling through said hole, thus creating a screened bottom board.

3) The bottom board of claim 1, wherein said board has a second groove opening that extends across the flat surface between said two parallel vertical walls, said second groove opening, and having a second tray therein.

4) The bottom board of claim 3, wherein said bottom board has a second aperture in one of said parallel vertical walls, and said second tray having one end that extends out through said second aperture.

5) The bottom board of claim 3, wherein screen wire of a size that easily permits honeybees to walk across the top of it without falling through the opening, but small hive beetles can fit through said screen wire, covers said second groove opening.

6) The bottom board of claim 5, wherein said first groove opening is near the side of the flat surface that has no vertical wall, and said second groove opening is near said third vertical wall.

7) The bottom board of claim 2, wherein said board has a second groove opening that extends across the flat surface between said two parallel vertical walls, and wherein said first groove opening is adjacent one side of said hole, while said second groove opening is adjacent the opposite side of said hole.

8) The bottom board of claim 7, said second groove opening covered over with screen wire of a size that easily permits honeybees to walk across the top without falling through the second groove opening, but small hive beetles can fit or fall through said screen wire.

9) The bottom board of claim 1, wherein said board and said vertical walls are made from wood.

10) The bottom board of claim 1, wherein said board and said vertical walls are made from plastic.

11) The bottom board of claim 2, wherein said parallel vertical walls each have a channel below said board, and a solid surface that fits within said channels and blocks off said hole.

12) The bottom board of claim 10 wherein said solid surface has one or more slits there through thereby substantially reduce the air flow through said hole.

13) The bottom board of claim 1, wherein said screen wire covering said first groove opening extends through said flat surface along the edge closest to the side of said flat surface having no vertical wall.

14) The bottom board of claim 1, wherein said screen wire covering said first groove opening is flat and on top of said flat surface.
